(19) United States
(12) Patent Application Publication
(10) Pub. No.: US 2003/0159460 A1
(43) Pub. Date: Aug. 28, 2003

(54) Bottled water cooler

(76) Inventor: A. Randy Netter, Powell River (CA)

Correspondence Address: RANDY NETTER, 5890 FRASER ST., POWELL RIVER, BC, V8A-4T5, CA

(21) Appl. No.: 10/084,070

(22) Filed: Feb. 27, 2002

(51) Int. Cl. B67D 5/62

(52) U.S. Cl. 62/389

(57) ABSTRACT

Most bottled water coolers are known to hold a bottle of water on top of the cooler unit where the water is gravity fed. The water is cooled and then dispensed by a levered spout. In this invention, the bottled water and the cooling/dispenser part of the water cooler unit are side by side. This invention utilizes the standard plastic 2 and 4 litre water bottles with handles. The bottled water is inserted upside down, with the handle forward, beside the dispenser/cooling part of the unit. An electric pump moves the water through a thermoelectric cooling device. The water is dispensed by a hands free, dispensing spout.

The invention relates to bottled water coolers that hold the bottled water on top of the cooler unit.

These cooler units are bulky and take up floor space in a kitchen or workplace. The bottles made for these units are large and heavy, that may result in back injuries at home or in the workplace, when trying to load the bottle in the cooler. The loading of bottles can not be done by any person of any age. The levered dispensing spout requires two hands to fill a glass or container.

The invention is designed in size, to be placed on the counter or mounted under the counter in a kitchen or workplace. The invention utilizes a standard size plastic water bottle of 2 and 4 litres that have handles. These plastic containers of water can be loaded into the cooler by a person of just about any age. The invention uses a hands free dispensing spout, requiring only one hand to hold the glass or container.

To use the invention, a person would simply take a 4 litre plastic water bottle by the handle, invert it upside down with the lid of the bottle still in tact and place the bottle in the left side of the unit, pushing down, piercing the lid with the water tube. The water is pumped through the cooling part of the unit and dispensed by pushing a glass or container against the lever attached to the spout.

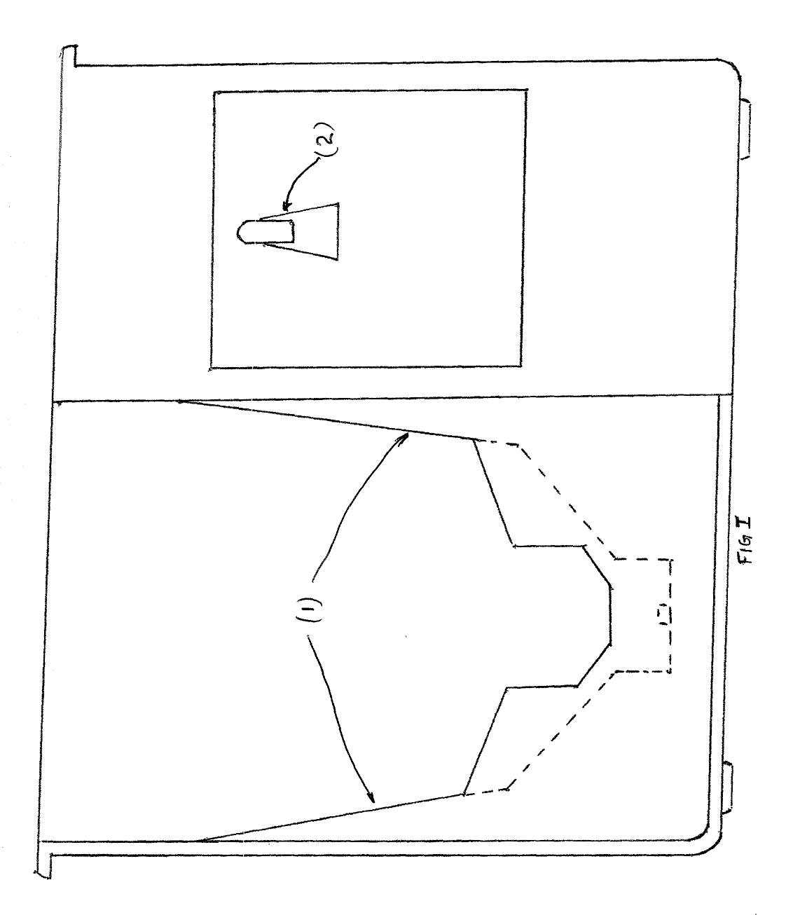

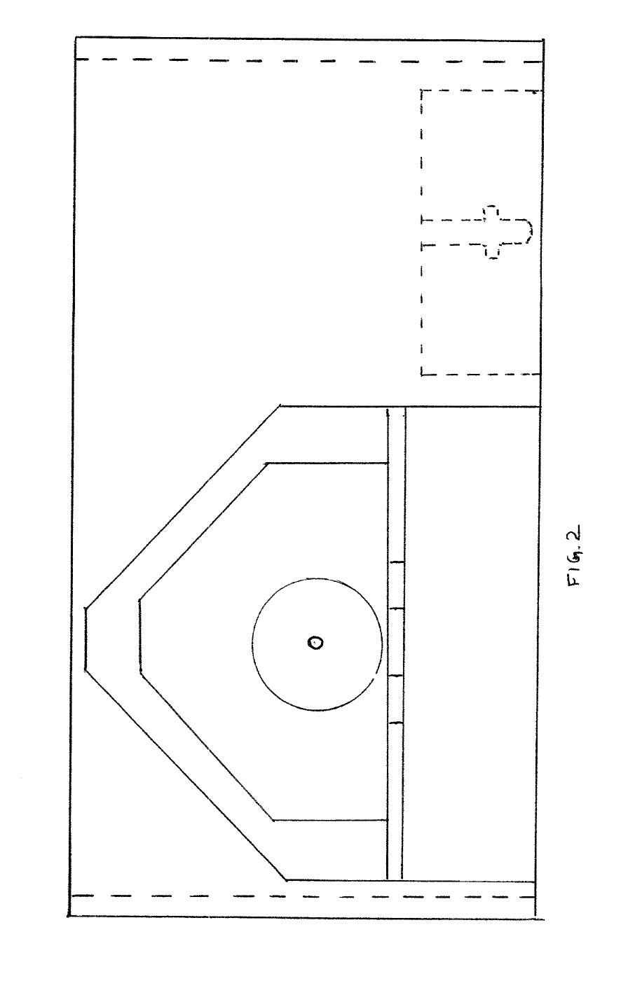

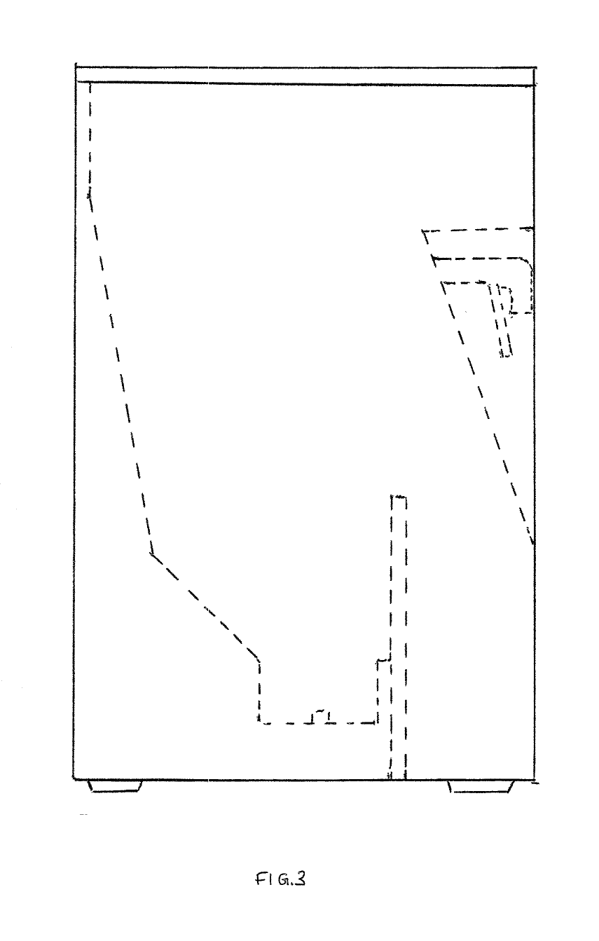

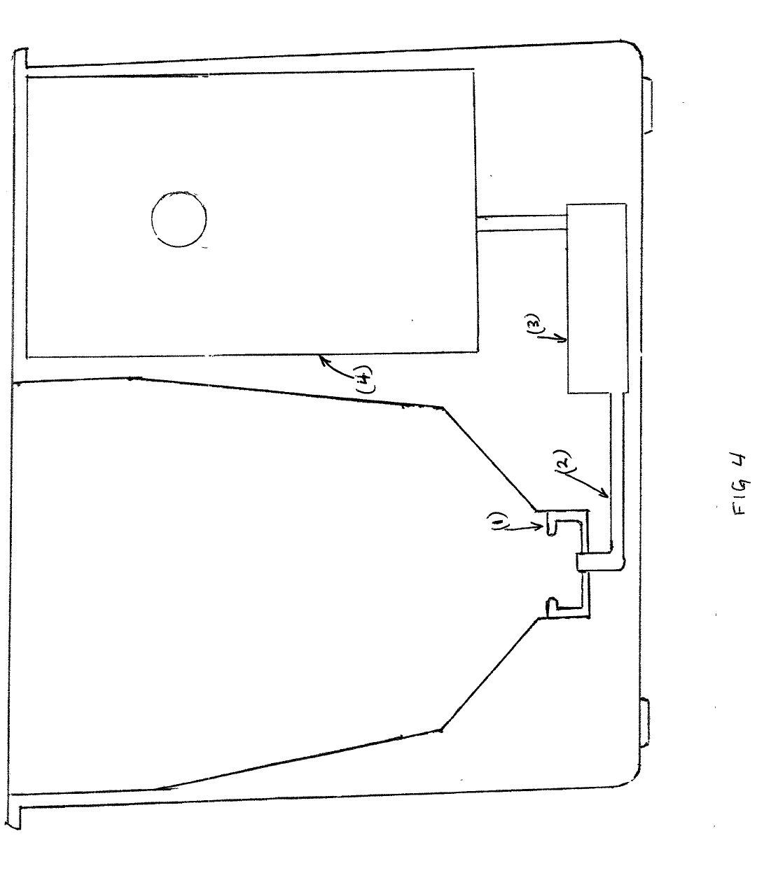

In drawings which illustrate embodiments of the invention, FIG. 1 is a front view, FIG. 2 is a top view, FIG. 3 is a left side view and FIG. 4 is a cross section of the front view.

FIG. 1(1): Tapered chamber in which the plastic container is inverted and placed into.

FIG. 4(1): The rubber seal which seals the lid of the plastic container to prevent leakage.

FIG. 4(2): The water tube which pierces the container lid and allows water to flow.

FIG. 4(3): Pressure release pump which pumps the water through the cooling device.

FIG. 4(4): The thermoelectic cooling device and water reservoir.

FIG. 1(2): The pressure release dispensing spout.

I claim as my invention,

1. A counter or under the counter, bottled water cooler with a tapered chamber that allows the inverted bottle container to be placed beside the cooling/dispensing section of the unit.

2. A rubber seal which prevents leakage of water from the lid of the plastic container once it is pierced by the water tube.

3. A water tube which pierces the lid of a water container and allows the flow of water to the pump.

4. A pressure release pump which pumps the water through the cooling device.

5. A recessed hands free delivery water spout.
